(19) United States
(12) Patent Application Publication
(10) Pub. No.: US 2006/0041451 A1
(43) Pub. Date: Feb. 23, 2006

(54) Lighting simulation for beauty products

(76) Inventors: Jennifer Hessel, New York, NY (US); William J. Schwinghammer, New York, NY (US); David Liatti, Brooklyn, NY (US); Stephen Feuerborn, Brooklyn, NY (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/195,734

(22) Filed: Aug. 3, 2005

Related U.S. Application Data
(60) Provisional application No. 60/598,592, filed on Aug. 4, 2004.

(51) Int. Cl. G06Q 50/00

(52) U.S. Cl. 705/2

(57) ABSTRACT

The present disclosure relates to simulating one or more lighting environments, allowing consumers to select and/or learn about beauty products and/or other products having and/or causing an appearance that varies depending on lighting conditions. Simulated lighting environments can also be used for development and testing of beauty products by determining the performance and interaction of one or more beauty products with other beauty products and/or various individual skin-tones, hair colors, etc. in the different lighting environments.

This application claims priority under 35 U.S.C. § 119(e) to U.S. Provisional Application No. 60/598,592, filed Aug. 4, 2004.

### BACKGROUND

The present invention may relate to simulating one or more lighting environments. Some examples may relate to creating a simulated lighting environment that allows consumers to select and/or learn about beauty products and/or other products having and/or causing an appearance that varies depending on lighting conditions.

Consumers spend billions of dollars every year on beauty products such as cosmetics (e.g., makeup), hair color, skin care, hair care, etc. Many purchased products can turn out to be unflattering, causing consumers to lose confidence in themselves and in product suppliers and services. Several factors contribute to these unsatisfactory results. One factor is that variations in lighting situations produce different appearances of certain color combinations, cosmetics, skin-tone, and hair colors. For example, a shade of makeup that may look good in lighting at a store may look terrible at home in front of a mirror or in sunlight. Another factor is the consumer's lack of understanding about their own physical attributes (e.g., skin tones and/or hair color) and the shades of cosmetics and/or hair colors that would most effectively accentuate and complement their natural appearance.

Accordingly, there is a need for method and system enabling evaluation in one or more simulated lighting environments.

### SUMMARY OF THE INVENTION

In the following description, certain aspects and embodiments will become evident. It should be understood that the invention, in its broadest sense, could be practiced without having one or more features of these aspects and embodiments. It should be understood that these aspects and embodiments are merely exemplary.

One aspect may relate to a light simulation system and method for use in providing individuals with beauty-related education and/or advice (e.g., consultations relating to hair color, hair care, skin care, cosmetic product selection, etc.) for particular lighting environments.

Another aspect may relate to a system and method that may simulate a variety of lighting environments corresponding to locations or activities of a particular person.

A further aspect may relate to a system and method of providing individuals with a better understanding of their own beauty needs (e.g., through the use or lighting and/or consultation).

Yet another aspect may relate to a method for recommending a beauty product. The method may include applying at least one beauty product to an individual; simulating various lighting environments; evaluating appearance of the individual in a plurality of the simulated lighting environments; and recommending at least one beauty product based on the evaluating.

As used throughout the application, the term “product” is used to generically refer to goods (e.g., tangible merchandise), services, and actions performed. A “beauty product” refers to a product (as defined above) for effecting one or more external body conditions (e.g., appearance), such as conditions of the skin, hair, and/or nails. Some exemplary forms of beauty products include cosmetic products, hair color products, hair care products, skin care products, makeup, and sunless tanning products. Examples of tangible merchandise forms of beauty products include cosmetic goods, such as treatment products, personal cleansing products, and makeup products, in any form (e.g., liquids, powders, cakes creams, gels, pastes, sprays, and lotions, etc.)

Examples of service forms of beauty products include hair coloring, hair styling, hair cutting, hair removal, skin treatment, make-up application, and any other offering for aesthetic enhancement. Examples of other actions performed include massages, facial rubs, deep cleansings, applications of beauty goods, exercise, therapy, or any other action effecting the external body condition, whether performed by a professional, the subject, or an acquaintance of the subject.

The following is an exemplary and non-exhaustive listing of a few beauty products—mascaras, eyeliners, lip liners, lipsticks, lip glosses, eyebrow liners, eye shadows, nail polishes, foundations, concealers, blushes, skin conditioners, skin toners, skin coloring agents, tanners, bronzers, skin lighteners, hair colorings, hair highlighters, hair cleansing, hair styling, hair straighteners and curlers, scrubs, rinses, washes, moisturizers, wrinkle removers, exfoliates, toners, cleansers, conditioners, shampoos, anti-aging products, anti-wrinkle products, anti-freckle products, and elasticity enhancing products.

In at least some aspects and examples, the term “recommending at least one beauty product” refers to the provision of beauty product related information to a subject. The recommending may include providing advice and/or guidance relating to one or more beauty products (e.g., recommendations for beauty products to improve the appearance of an individual in one or more lighting conditions). For example, the recommendation may be a suggestion to purchase one or more beauty products. The recommendation could be communicated in any manner (e.g., verbally from a personal consultant, electronically via a prerecorded message, electronically via e-mail or the internet, and/or textually via a display or printed sheet).

Another aspect may relate to a method of comparing an individual's hair, either colored or natural, to one or more samples in one or more lighting simulated environments, for example, to educate an individual about the color of the individual's hair. One or more beauty products may then be recommended or selected, for example, so as to cause accentuating (e.g., with other beauty products), enhancing, and/or changing hair color.

One more aspect may relate to a method that includes causing at least one beauty product to be applied to an individual; simulating various lighting environments; evaluating the appearance of the individual in a plurality of the various lighting environments; and selecting at least one beauty product based on the evaluating.

Still another aspect may relate to a beauty-related system, including an area defined by at least one wall, wherein the area is configured to enable an individual to be situated in at least one location within the area; a plurality of lighting devices, each device having a plurality of lighting elements, wherein at least one of the plurality of lighting devices is located above the location, and another of the plurality of lighting devices is located adjacent the location; a memory configured to store information relating to a plurality of simulated lighting environments, each simulated lighting environment being associated with at least one of a location, weather condition, and time of day; and a control device configured to control the lighting elements so as to cause at least one of the simulated lighting environments.

One further aspect may relate to a system and method involving a lighting pod defining an at least partially enclosed shape (e.g., an enclosed or semi-enclosed space) with a plurality of lighting devices controlled by a controller. Each of the lighting devices may include several lighting elements. At least some the lighting elements may output a different light temperature and at least some of the elements may be independently controlled to reproduce and/or approximate a substantially full-color spectrum of a multitude of lighting environments.

One more aspect may relate to a method and system for enhancing an individual's understanding and awareness of beauty products. This aspect may involve creating a simulated lighting environment that allows one or more consumers to educate themselves, with or without the aid of a beauty consultant, about beauty products and how to select beauty products that are most effective in a variety of lighting environments. A beauty product may be applied to an individual, and lighting environments may be simulated. The appearance of the individual may be evaluated in various lighting environments, allowing the selection and/or recommendation of particular beauty products.

Another aspect may relate to a method for developing beauty products (e.g., research and development of beauty products). The method may involve applying at least one beauty product to a surface (e.g., hair, eyelashes, eyebrows, a finger nail, a toe nail, and/or skin); simulating various lighting environments; evaluating appearance of the surface in a plurality of the simulated lighting environments; and selecting, based on the evaluating, the at least one beauty product for commercialization, and/or causing, based on the evaluating, a change to the at least one beauty product (e.g., change in composition, change in color, change in targeted consumer, abandonment of product).

One more aspect may relate to a method for recommending and/or selecting a hair product. The method may include simulating at least one lighting environment; evaluating appearance of an individual's hair in the simulated lighting environment; comparing the appearance of the individual's hair color to at least one sample; and recommending and/or selecting at least one hair product based on the comparing.

Aside from the structural and procedural arrangements set forth above, the invention could include a number of other arrangements, such as those explained hereinafter. It is to be understood that both the foregoing description and the following description are exemplary.

### BRIEF DESCRIPTION OF THE DRAWINGS

The accompanying drawings are incorporated in and constitute part of this specification. The drawings illustrate exemplary embodiments and, together with the description, serve to explain some principles of the invention.

FIG. 1 is a flowchart of an exemplary method according to one or more aspects of invention.

FIG. 2 is a schematic illustration of an embodiment of a system in accordance with the invention.

FIG. 3 is a pictorial representation of an exemplary simulation of a daytime lighting environment.

FIG. 4 is a pictorial representation of an exemplary simulation of a soft lighting environment.

FIG. 5 is a pictorial representation of an exemplary simulation of a restaurant lighting environment.

FIG. 6 is a pictorial representation of an exemplary arrangement of lighting elements in a vertical cylinder lighting device.

FIG. 7 is a schematic illustration of an exemplary arrangement of lighting elements in a horizontal lighting device.

FIG. 8 is a schematic illustration of an exemplary pod of the system.

FIG. 9 is a schematic illustration of a portion of the pod of FIG. 8.

### DETAILED DESCRIPTION

Reference will now be made in detail to the exemplary embodiments of the invention, examples of which are illustrated in the accompanying drawings. Wherever possible, the same reference numbers will be used throughout the drawings to refer to the same or like parts.

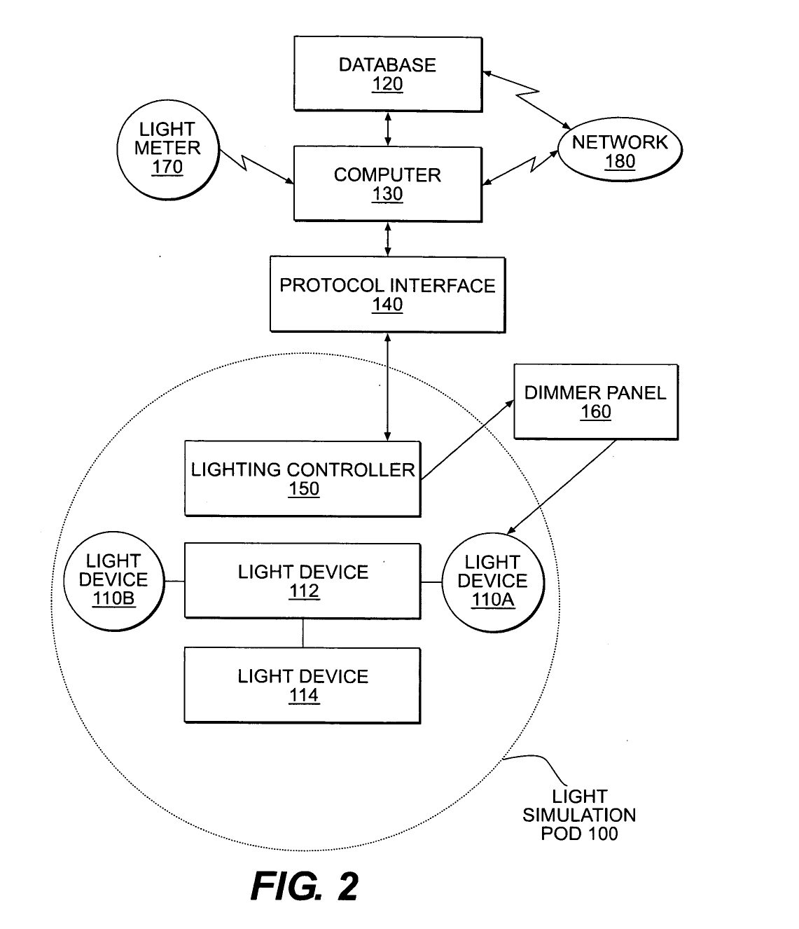

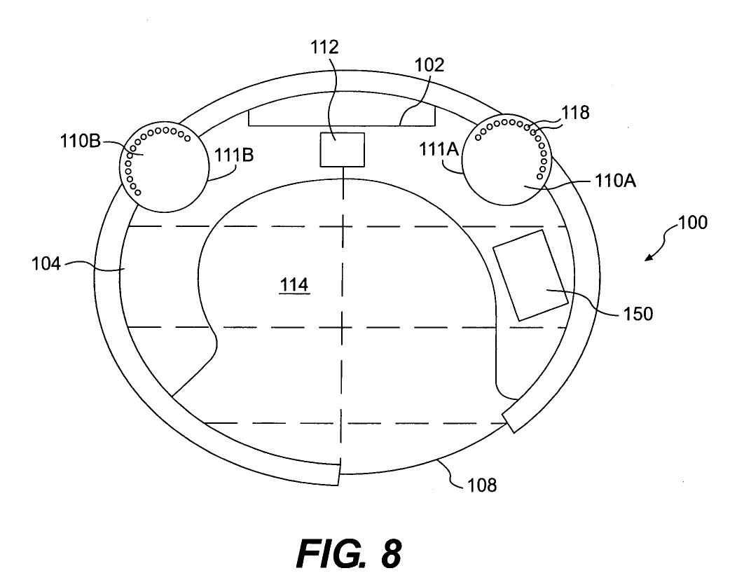

In some embodiments, there is a pod 100 (FIGS. 2 and 8) in the form of an area defined by at least one wall. The area can be configured to allow for one or more people to be seated. The area and wall could define a controlled-lighting room located in a desirable location. For example, the pod 100 could be located at a facility that provides beauty-related treatments and/or sells beauty products. Alternative locations are also possible (e.g., when the pod is used for research and development of products).

In some embodiments, as shown in FIGS. 2-7, the pod 100 includes several lighting devices, such as, for example, two or more vertical lighting towers 110A, 110B, and an overhead lighting dome 114. (To facilitate the description of the towers 110A and 110B, the text and drawings use the reference symbol “110” interchangeably with the symbols 110A and 110B.) The pod 100 may also include a table 104 positioned next to a mirror 102, a computer 130, and a lighting controller 150 (e.g., digital dimming controller) interconnecting the computer 130 to various lights in the towers, dome, and table. Each tower 110 is positioned on a respective side of the table 104 so that an individual sitting in a chair next to the table 104 and looking into the mirror 102 has their face illuminated by light from the towers 110 and the overhead lighting dome 114.

During use, an operator (e.g., the individual sitting at the table and/or a sales consultant in a store where the pod is located) uses the computer 130 (e.g., via the controller 150) to call up a particular simulated lighting environment, and software on the computer 130 interacts with the lighting controller 150 to control the lighting elements in the pod (e.g., the lights in the towers 110, the lights in the dome 114, and a table light 112) to provide a lighting simulation of that environment. At least some (e.g., all or less than all) of the lamps may be controlled separately to emit a particular combination of light to simulate a particular selected lighting environment.

The computer 130 may be connected to a lighting protocol interface device 140, such as a Lutron GRX-PRG. The protocol device 140 may be connected to the lighting controller 150, (e.g., a Lutron GRAFIK Eye GRX-4524), which in turn may be connected to a dimmer panel 160, such as a Lutron GP4000 series panel, which connects to each lighting device and element. The system may be programmed so that a user can select desired simulated lighting environments from a database 120 and assign them to be selected on the controller 150. Each of these elements can be located in different areas in and around the pod 100. Several lighting controllers 150 may also be used to allow the pod 100 to be operated from either inside or outside of the pod 100.

The computer 130 may control the simulated lighting environments by controlling the output of each of the lighting devices in the pod 100. The database 120, which includes a memory, may store data relating to the simulated lighting environments. The database 120 may be connected to a network 180, such as the internet or an intranet, allowing information about different simulated lighting environments to be shared among different geographic locations (e.g., stores) or light pods in the same geographic location (e.g., store). Each location or light pod 100 may maintain its own database 120. Further, the computer 130 may function as the controller 150, the database 120, and the protocol device 140.

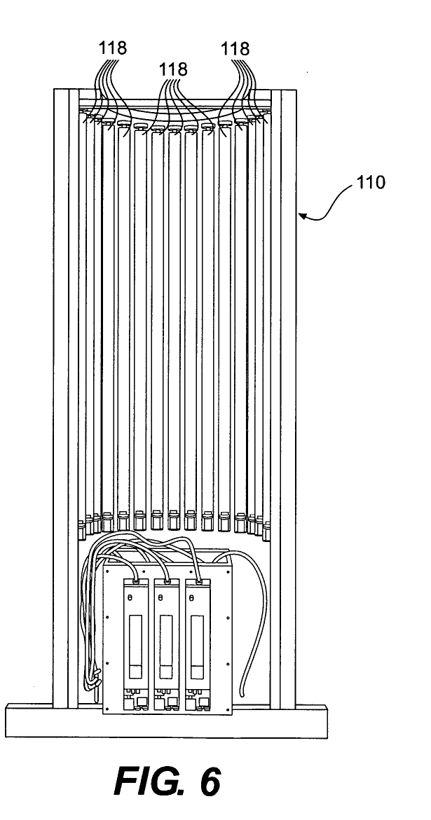

Each lighting device is positioned in or around the pod 100 to allow light to be effectively simulated for an individual situated (e.g., sitting) in the pod 100. Each tower 110 has multiple lighting elements 118 (FIG. 6) including elongated tubular fluorescent lamps each having differing color temperatures and color rendering indexes. Other arrangements are possible. For example, in some alternative embodiments, one or more of the towers 110 may have at least one halogen light, and possibly also one or more LEDs and/or incandescent lights. Some examples may include the halogen and incandescent lights in a tube configuration, similar to the fluorescent lamps.

As shown in FIGS. 6, 8, and 9, each tower 110 may be generally in the form of a cylinder with fluorescent tubes on the interior surface of about half of the diameter of the cylinder and with a curved diffusing cover 111A, 111B (FIG. 8) on the other half of the cylinder. The cylindrical design may allow the different color temperatures and color rendering indexes from each lighting element to mix and emit from the diffuser as an integrated light source.

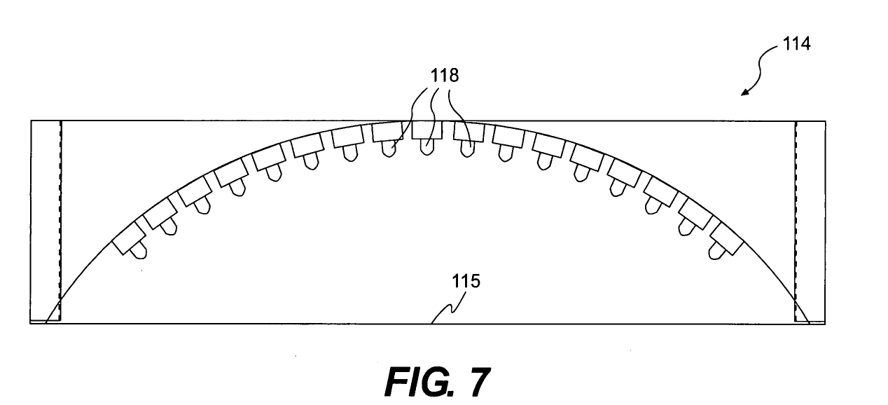

As shown in FIG. 7, the overhead lighting dome 114 may have multiple lighting elements arranged in a curved manner similar to the towers. Rather than having a curved diffuser, the dome 114 may have a flat diffuser 115 defining a ceiling of the pod 100. The lighting dome 114 may be positioned directly above the table 104 in a horizontal orientation.

A portion of the flat top surface of the table 104 may be defined by the lighting device 112, which includes a diffuser housing a “candelabra” light that simulates candlelight. The table lighting device 112 may also have multiple lighting elements. The interior area of the pod 100 may be arranged so that an individual positioned adjacent to the table 104 (e.g., seated at a chair positioned next to the table or standing next to the table) may be illuminated with light from the lighting devices.

The combination and positioning of the different lighting devices may complement each other so that controlling the light emitted from each lighting device may provide a variety of simulated lighting environments. The inside of the pod 100 may have white or neutral colors so as to minimize the light from the lighting devices being refracted and/or picking up additional colors.

In order to replicate the lighting environments at a given location, one or more light meters 170 (FIG. 2) (e.g., a chroma meter for measuring color temperature and exposure (i.e., light intensity) and possibly also a radio spectrometer for measuring spectral intensity) may be used to measure lighting environments at various places and times (e.g., at certain restaurants or clubs, average office environments, average home environments, at the beach, in full sun, in the morning, at sunset, in cloudy environments, in hazy environments, at different cities and vacation destinations, etc.) and the light meter data may entered into the database 120 and stored as a particular lighting environment. The particular lighting environment may then be simulated in the pod 100 when desired. Each simulated lighting environment may be simulated by controlling the output of each lighting element in each lighting device separately or in groups such that the combined output in the pod 100 simulates the desired lighting environment.

To ensure that the particular lighting environment may be somewhat accurately simulated, the light meter 170 may be used to measure light in the pod 100 and those measurements may be used to calibrate the pod 100 by comparing the measured lighting in the pod 100 to the original lighting data stored for the particular lighting environment, and then modifying the output of the various lighting devices until the pod lighting environment most closely resembles the original light readings for that particular lighting environment. This calibration may be done when the particular lighting environment is first simulated after collecting the readings, and/or may be done on a continual basis, allowing the pod 100 to correct any variations possibly associated with changes in light from the various lighting elements over time. The calibration may also be used for indicating when it may be desired to replace any or all of the lighting elements.

The database 120 can be updated as desired. In some instances, the data may be updated to address particular regional preferences. For example, an individual from New York City might be interested in the lighting environments in various trendy New York restaurants and at a beach in the Hamptons, while an individual in Chicago might be interested in local trendy Chicago restaurants and the ski slopes of Aspen. The database may include favorite locations for particular regions, and may also store a list of the preferred lighting environments for a particular individual, e.g., allowing the individual to quickly evaluate and select new beauty products (e.g., cosmetics) on a return visit.

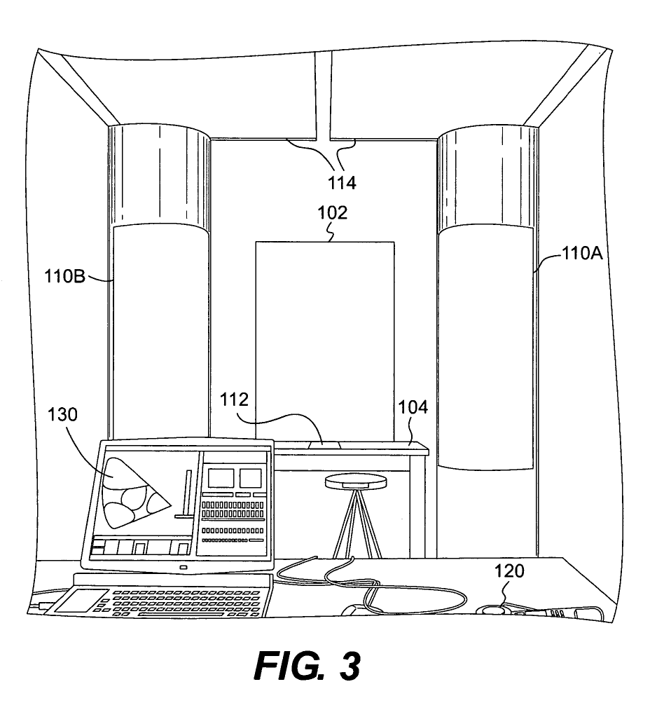

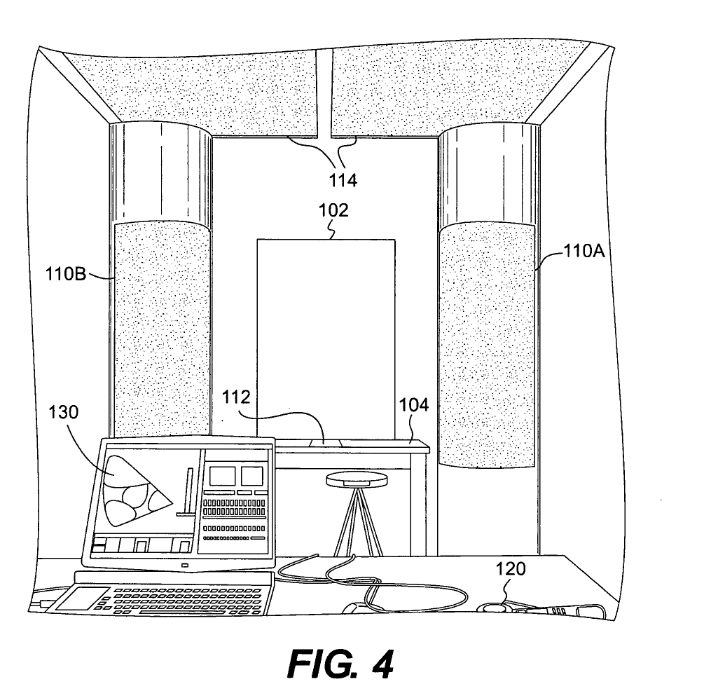

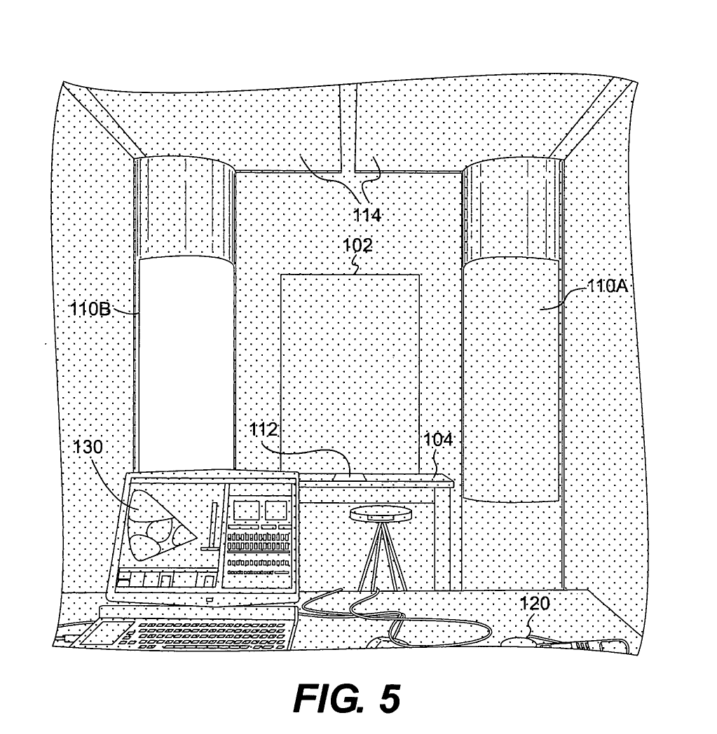

Some examples of different simulated lighting environments are shown in FIGS. 3-5. FIG. 3 is a pictorial representation of a daytime lighting environment, with each of the lighting devices 110A, 110B, 114 emitting light with a spectral and color temperature approximating daytime lighting. FIG. 4 is a pictorial representation of a soft lighting environment, with each of the lighting devices 110A, 110B, 114 emitting light with a spectral and color temperature approximating indoor, soft lighting. FIG. 5 is a pictorial representation of a candle-lit lighting environment (e.g., in a restaurant), with some of the lighting devices 110B, 112 emitting light with a spectral and color temperature approximating a candlelight dinner or evening.

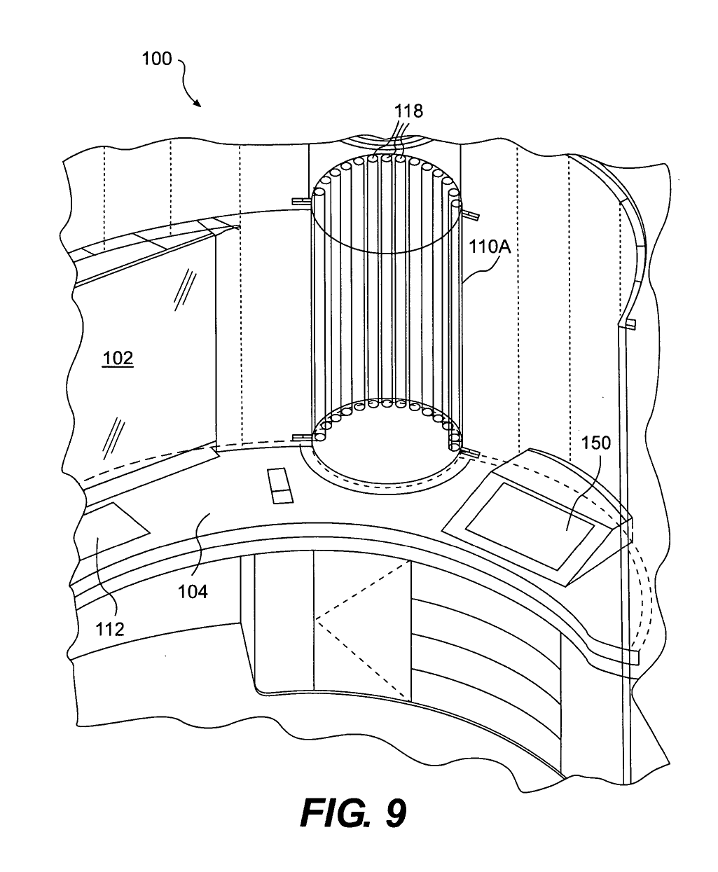

As shown in FIGS. 8 and 9, in one embodiment, the pod 100 may include a generally circular or oval shaped enclosure defined by at least one wall. Although the pod 100 can be any shape or size, curved walls may allow the light to be mixed and distributed better, limiting shadows and other lighting variations in the pod 100. A door 108 may also be used to enclose the pod 100 fully, ensuring that little or no ambient light enters the pod 100, to provide a more accurate representation of specific lighting environments.

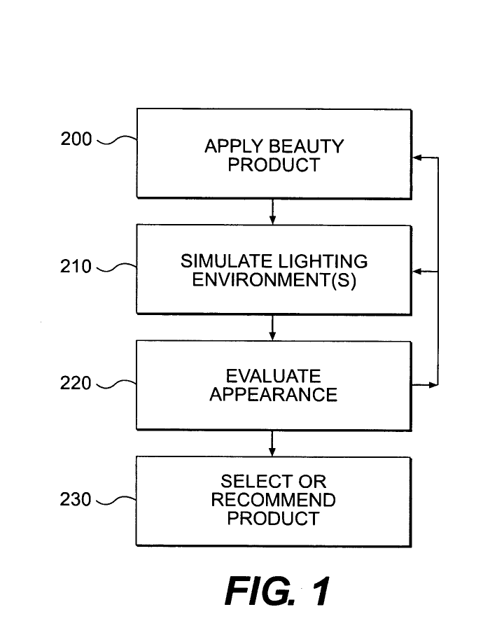

FIG. 1 illustrates an exemplary method in accordance with the invention. The method of FIG. 1 may relate to selecting and/or recommending a beauty product. Although various methods are described in connection with the pod 100 and other features of the system of FIGS. 2-9, the methods could be practiced with numerous alternative structural arrangements.

In some examples, an individual enters the pod 100, possibly along with a beauty consultant. A beauty product, or variety of beauty products, may then be applied to the individual (e.g., by the individual personally and/or by a possible beauty consultant) (200 of FIG. 1). Numerous types of beauty products may be applied either in combination, or subsequent to one another. Similar beauty products may be applied together for comparison purposes. For example, one shade of eye-shadow may be applied to one eye and another shade to the other eye so as to enable visualization of the difference between the two in differing lighting simulations. Also, the combinations of products applied can be varied, for example, to show how each product appears on the individual and with the other beauty products. Various different beauty products (e.g., cosmetics) can also be removed and applied while an individual uses the pod 100.

A variety of lighting environments may be simulated in the pod 100 (210 of FIG. 1). For example, various simulated lighting environments may be selected according to the lifestyle and/or needs of the individual. Examples of some simulated lighted environments include the following: the individual's home bathroom, or similar location, where the individual usually applies cosmetic products; an office environment; a candle-lit evening (e.g., restaurant); various home environments; outdoor locations; a destination, such as a particular restaurant, club, beach, city, vacation destination, etc.; or any other locations of interest to the individual. The simulated lighting environments may also reflect times of day (for example, lighting is different in the morning than in the middle of the day). Weather conditions affecting lighting may also be simulated, such as the lighting conditions on a cloudy day and the lighting conditions on a sunny day.

As the simulated lighting environments are varied, the individual (e.g., through the use of a mirror 102 in the pod 100) and/or a beauty consultant may then evaluate the appearance of the individual by visualizing the effect of different simulated lighting environments on the individual's appearance (220 of FIG. 1). For example, the lighting environment simulations may alter the appearance of the applied beauty product(s) as well as the appearance of the individual's own skin, hair, and clothing. The individual and/or the beauty consultant may then evaluate the beauty product(s) in the different simulated lighting environments to determine the particular colors, products, and/or combinations of products producing desired appearances in one or more of the simulated lighting environments.

For example, the individual and/or consultant may be able to evaluate the beauty product(s) appearing to be the most flattering in selected lighting environments, and the beauty product(s) giving the best overall results among many simulated lighting environments. For example, one product may look good in the incandescent lighting of a home bathroom, but may be unflattering in mid-day light. Another product may be very appealing at the beach, but bland in candlelight. The beauty consultant may also educate the individual about skin-tones, hair color, etc., including the individual's own skin-tone, hair color, etc., and the effects of different colors and shades of various beauty products on various skin-tones and hair colors. The beauty consultant may also provide the individual with information about how various beauty products look on the individual based on the individual's skin-tone, hair color, etc. in different lighting environments.

A selected lighting environment for evaluation may be a full-spectrum environment to allow the beauty consultant and/or the individual to evaluate the true skin-tone, hair color, etc. of the individual without any light shading.

The beauty consultant may then recommend (and/or the individual may then select) the appropriate beauty product(s) for the individual based on the evaluation of products in different simulated lighting environments (230 of FIG. 1) and on the specific skin-tone, hair color, etc. of the individual as seen in the different simulated lighting environments. The recommendation may include a list of a variety of products with information about how each product performed in the different simulated lighting environments for the individual. Alternative recommendations are also possible.

The recommendation may be communicated to the individual in a variety of ways. For example, the recommendation may be communicated orally, via electronic or printed display, electronically via the internet and/or e-mail, etc.

The individual may be enabled to purchase the recommended and/or selected beauty products. For example, the purchase could take place at a bricks-and-mortar store where the pod is located and/or the purchase could take place electronically via a kiosk or other electronic interface. Such a purchase may be made with a certain level of confidence, knowing generally how the beauty products appear in various lighting environments. The individual may then have the confidence and knowledge to select the appropriate beauty product to match a particular activity, location, desired effect, etc. This increased awareness may also build goodwill for the entity or entities providing the beauty consultation and recommendation.

The simulated lighting environments may be used to evaluate individual products or combinations of products to determine the product(s) for a particular lighting environment. The simulated lighting could also be associated with evaluating other items such as jewelry, clothes, other fashion items, eyeglasses, etc., either alone or in combination with other beauty products and accessories.

Although some examples are discussed in connection with facilities that provide and/or sell beauty products, certain methods and systems in accordance with the invention may be used in connection with research and development of beauty products. For example, a test beauty product may be evaluated in a variety of lighting conditions.

In some exemplary methods, based on the evaluating, one or more products may be selected and/or one or more actions may be taken to cause a change in the test product. Such evaluations may be used to determine if any changes to the composition, color, design, style, etc. of a test product should be made, and whether or not continue with the development and marketing of a particular test product.

Test products may be evaluated with a variety of real or simulated skin-tones, hair colors, body types, etc. to determine the best application and target consumers for a commercial version of a test product. For example, two hair color products could be evaluated by applying one product to one portion of an individual's hair and the other product to another portion of the individual's hair and then evaluating the appearance of the individual's hair in one or more simulated lighting environments.

In some embodiments, the pod 100 can be used in a full-service beauty consultation. Such a consultation may include evaluations of skin (tone, wrinkles, health, etc.) and hair (color, type, health, etc.), including recommendations for beauty products that best enhance the beauty of the individual. For example, full daytime light reveals more wrinkles and fine lines than evening or indoor lighting. Similarly, true daytime light reveals hair highlights and colors not seen otherwise. By presenting a complete evaluation in a variety of lighting conditions, the most effective beauty products can be recommended and/or selected for each individual.

In some examples, samples, such as hair swatches, may be used to educate an individual about their hair color in one or more lighting environments. By knowing the appearance of their hair in certain lighting environments, an individual may be more likely to select a beauty product that works well for their particular hair color, and an individual may also be better able to select appropriate beauty products that complement one another, such as a particular hair coloring and complementary cosmetic products for that hair color. The use of a hair sample may also enable an individual to better predict the likely outcome of a hair color and/or hair treatment product in different lighting environments.

In other embodiments, the lighting devices may be in various shapes and locations, such as in the floor, along vertical surfaces in the walls, or in separate, mobile lighting devices that can be moved and repositioned throughout the pod 100. The individual lighting elements, such as the fluorescent lamps 118, may be in a variety of shapes and sizes, depending on the location and specific shape of the lighting device.

In other embodiments, the pod 100 may be mobile. Certain hardware, including the electronic components and the lighting elements may be mobile or associated with a mobile vehicle, such as a truck, bus, trailer, motor home, etc. The mobile pod may be moved to different locations for use in places such as various retail stores, trade shows, individual houses, etc. An existing space in various locations may be used, or a temporary booth or structure may be assembled and disassembled on site.

In other embodiments, the individual may be able to participate in updating the database with specific lighting environment information. For example, the individual, or another person, may be able to collect a light reading at a desired location, and that information may then be uploaded into the database for future use.

In other embodiments, the computer may function alone as a lighting controller, using a software protocol instead of a hardware protocol device.

It will be apparent to those skilled in the art that various modifications and variations can be made to the structure and methodology of the present invention. Thus, it should be understood that the invention is not limited to the examples discussed in the specification. Rather, the present invention is intended to cover modifications and variations.

1. A method for recommending a beauty product, comprising:
applying at least one beauty product to an individual;
simulating various lighting environments;
evaluating appearance of the individual in a plurality of the simulated lighting environments; and
recommending at least one beauty product based on the evaluating.

2. The method of claim 1, wherein the at least one beauty product is a first product, and wherein the method further comprises applying a second beauty product to the individual, wherein the evaluating comprises comparing the appearance of the individual when the first beauty product is applied and the appearance of the individual when the second beauty product is applied.

3. The method of claim 2, wherein the first and second beauty products are evaluated concurrently.

4. The method of claim 2, wherein the first and second beauty products are evaluated consecutively.

5. The method of claim 2, wherein the first and second beauty products are complementary.

6. The method of claim 2, wherein the first and second beauty products are the same kind of product.

7. The method of claim 2, wherein the first beauty product is applied to one portion of the individual and the second beauty product is applied to another portion of the individual.

8. The method of claim 1, further comprising providing information about at least one of skin tone, hair color, and hair care.

9. The method of claim 1, wherein the recommending comprises recommending a product providing an appearance desired by the individual.

10. The method of claim 1, wherein each of the simulated lighting environments is associated with at least one of a location, weather condition, and time of day.

11. The method of claim 1, wherein at least one of the simulated lighting environments is associated with a location, wherein the location is one of a restaurant, a club, a recreational area, or workplace.

12. The method of claim 11, wherein the location is a specific location.

13. The method of claim 10, wherein at least one of the simulated lighting environments is based on information obtained at at least one specific location.

14. The method of claim 1, wherein information relating to the simulated lighting environments is stored in a memory.

15. The method of claim 14, wherein the simulating includes:
accessing the memory;
selecting a simulated lighting environment;
retrieving information relating to the selected simulated lighting environment from the memory; and
controlling a plurality of lighting devices so as to cause the selected simulated lighting environment.

16. The method of claim 1, further comprising offering the recommended beauty product for sale.

17. The method of claim 1, wherein the simulating occurs in a store where beauty products are offered for sale.

18. The method of claim 1, wherein the beauty product comprises at least one of a makeup, a hair care product, a hair color product, and a skin care product.

19. The method of claim 1, wherein the evaluating comprises viewing the individual via a mirror.

20. The method of claim 1, wherein the simulating comprises simulating light from a candle.

21. A method for selecting a beauty product, comprising:
causing at least one beauty product to be applied to an individual;
simulating various lighting environments;
evaluating the appearance of the individual in a plurality of the various lighting environments; and
selecting at least one beauty product based on the evaluating.

22. A beauty-related system, comprising:
an area defined by at least one wall, wherein the area is configured to enable an individual to be situated in at least one location within the area;
a plurality of lighting devices, each of the devices comprising a plurality of lighting elements, wherein at least one of the plurality of lighting devices is located above the location, and another of the plurality of lighting devices is located adjacent the location;
a memory configured to store information relating to a plurality of lighting environments, each of the plurality of lighting environments being associated with at least one of a location, weather condition, and time of day; and
a control device configured to control the lighting elements so as to cause at least one of the simulated lighting environments.

23. The system of claim 22, wherein at least one of the plurality of lighting devices is substantially vertically oriented with respect to a floor of the area.

24. The system of claim 22, wherein at least one of the plurality of lighting elements is an incandescent light.

25. The system of claim 22, wherein at least one of the plurality of lighting elements is a fluorescent tube.

26. The system of claim 22, wherein each of the plurality of lighting elements is elongated.

27. The system of claim 22, wherein at least some of the plurality of lighting elements are elongated.

28. The system of claim 22, wherein at least one of the plurality of lighting environments is based on light readings at a specific location.

29. The system of claim 22, wherein one of the plurality of lighting elements is associated with a horizontal surface so as to simulate light at a table.

30. The system of claim 22, further comprising a mirror.

31. The system of claim 30, wherein the area is at least substantially enclosed.

32. The system of claim 31, wherein the at least one wall is curved.

33. The system of claim 22, wherein at least one of the plurality of lighting devices comprises a curved diffuser, and wherein at least some of the plurality of lighting elements are tubular and arranged vertically.

34. The system of claim 22, wherein at least one of the lighting devices has a generally cylindrical shape.

35. The system of claim 22, wherein the memory is configured to be coupled to a database, and to retrieve or upload selected lighting environments.

36. A method for developing a beauty product, comprising:
applying at least one beauty product to a surface;
simulating various lighting environments;
evaluating appearance of the surface in a plurality of the simulated lighting environments; and
selecting, based on the evaluating, the at least one beauty product for commercialization and/or
causing, based on the evaluating, a change to the at least one beauty product.

37. The method of claim 36, wherein the surface comprises at least one of hair, eyelashes, eyebrows, a finger nail, a toe nail, and skin.

38. The method of claim 36, wherein the change comprises a change of the composition of the beauty product.

39. A method for recommending and/or selecting a hair product, comprising:
simulating at least one lighting environment;
evaluating appearance of an individual's hair in the simulated lighting environment;
comparing the appearance of the individual's hair color to at least one sample; and
recommending and/or selecting at least one hair product based on the comparing.

40. The method of claim 39, wherein the hair product is a hair color product.

41. The method of claim 39, wherein the sample comprises a hair sample.

42. The method of claim 39, wherein the evaluating comprises evaluating appearance of the individual's hair in a plurality of simulated lighting environments.

43. The method of claim 39, wherein the simulated lighting environment comprises a simulation of outdoor sunlight.

44. The method of claim 1, further comprising recommending at least a second product, wherein the second product is at least one item of clothing.

45. A method for recommending a product for purchase, comprising:
associating a product with an individual;
simulating various lighting environments;
evaluating an appearance of the individual in a plurality of the simulated lighting environments; and
recommending at least one product for purchase based on the evaluating.

46. The method of claim 45, wherein the product is at least one of clothing, jewelry, and a beauty product.

47. The method of claim 46, wherein the product is clothing.

48. A method for selecting a product in a store, comprising:
causing a product to be placed on an individual;
simulating various lighting environments;
evaluating an appearance of the individual in a plurality of the simulated lighting environments; and
selecting at least one product for purchase at the store based on the evaluating.

49. The method of claim 48, wherein one of the plurality of simulated lighting environments is a simulation of candlelight.

50. The method of claim 48, wherein one of the plurality of simulated lighting environments is a simulation of a softly lit restaurant.

51. The method of claim 48, wherein one of the plurality of simulated lighting environments is a simulation of full sunlight.

52. The method of claim 48, wherein the simulating various lighting environments is controlled by the individual.

53. The method of claim 48, wherein the product is clothing.
